(19) United States
(12) Patent Application Publication
(10) Pub. No.: US 2022/0074751 A1
(43) Pub. Date: Mar. 10, 2022

(54) METHOD, APPARATUS, AND SYSTEM FOR PROVIDING AN ESTIMATED TIME OF ARRIVAL WITH UNCERTAIN STARTING LOCATION

(71) Applicant: HERE GLOBAL B.V., Eindhoven (NL)

(72) Inventors: Nimrod KLANG, Raanana (IL); Herman RAVKIN, Beer Yakov (IL); Shahar KATZ, Tel Aviv (IL)

(21) Appl. No.: 17/013,158

(22) Filed: Sep. 4, 2020

(51) Int. Cl. G01C 21/34; G01C 21/00; G06N 20/00

(52) U.S. Cl. CPC G01C 21/3492; G01C 21/38; G06N 20/00; G01C 21/3484; G01C 21/3407

(57) ABSTRACT

An approach is provided for providing an estimated time of arrival (ETA) with a uncertain starting location. The approach, for example, involves determining an uncertainty time window that spans from a timestamp of a location point of a sparse location data feed to a time of interest. The approach also involves determining a speed of the device at the location point based on the location data feed. The approach further involves processing map data based on the speed to predict possible locations to which the device may have traveled during the uncertainty time window and to determine one or more respective probabilities of the device has traveled to the possible locations. The approach further involves determining respective ETA at a destination from the possible locations. The approach further involves calculating a total estimated time of arrival based on the respective estimated times of arrival and the respective probabilities.

### BACKGROUND

Navigation and travel related services (e.g., ride-hailing, ridesharing, etc.) often rely on accurate calculation of estimated times of arrival (ETAs). The accuracy of ETA calculations can often depend on the accuracy of input parameters such as starting locations and routes taken by a vehicle or user. In many cases, these parameters are determined from sparse location sensor data feeds that include location data points captured at designated sampling frequencies (e.g., every 5 seconds, 10 seconds, 30 seconds, etc.). This sparse data creates an uncertainty time window or time delta error between any two location data points during which the vehicle/user's location and/or route taken is uncertain or not known. The uncertainty can lead to less certain or less accurate ETAs particularly on shorter routes where the length of the uncertainty time window represents a larger portion of the overall trip length. Accordingly, service providers face significant technical challenges to provide accurate ETA calculation when location data is sparse.

### SOME EXAMPLE EMBODIMENTS

Therefore, there is a need for provide an estimated time of arrival (ETA) when ETA input parameters (e.g., location data feeds, starting locations, etc.) are sparse or uncertain.

According to one embodiment, a method comprises determining, by a processor, an uncertainty time window that spans from a timestamp of a location point of a sparse location data feed to a time of interest. The sparse location data feed is determined from at least one location sensor of a device. The method also comprises determining a speed of the device at the location point based on the sparse location data feed. The method further comprises processing map data based on the speed to predict one or more possible locations to which the device may have traveled during the uncertainty time window and to determine one or more respective probabilities of the device has traveled to the one or more possible locations. The method further comprises determining one or more respective estimated times of arrival (ETAs) at a destination from the one or more possible locations. The method further comprises calculating a total estimated time of arrival based on the one or more respective ETAs and the one or more respective probabilities. The method further comprises providing the total estimated time of arrival as an output to a location-based service.

According to another embodiment, an apparatus comprises at least one processor, and at least one memory including computer program code for one or more computer programs, the at least one memory and the computer program code configured to, with the at least one processor, cause, at least in part, the apparatus to determine an uncertainty time window that spans from a timestamp of a location point of a sparse location data feed to a time of interest. The sparse location data feed is determined from at least one location sensor of a device. The apparatus is also caused to determine a speed of the device at the location point based on the sparse location data feed. The apparatus is further caused to process map data based on the speed to predict one or more possible locations to which the device may have traveled during the uncertainty time window and to determine one or more respective probabilities of the device has traveled to the one or more possible locations. The apparatus is further caused to determine one or more respective estimated times of arrival (ETAs) at a destination from the one or more possible locations. The apparatus is further caused to calculate a total estimated time of arrival based on the one or more respective ETAs and the one or more respective probabilities. The apparatus is further caused to provide the total estimated time of arrival as an output to a location-based service.

According to another embodiment, a computer-readable storage medium carries one or more sequences of one or more instructions which, when executed by one or more processors, cause, at least in part, an apparatus to determine an uncertainty time window that spans from a timestamp of a location point of a sparse location data feed to a time of interest. The sparse location data feed is determined from at least one location sensor of a device. The apparatus is also caused to determine a speed of the device at the location point based on the sparse location data feed. The apparatus is further caused to process map data based on the speed to predict one or more possible locations to which the device may have traveled during the uncertainty time window and to determine one or more respective probabilities of the device has traveled to the one or more possible locations. The apparatus is further caused to determine one or more respective estimated times of arrival (ETAs) at a destination from the one or more possible locations. The apparatus is further caused to calculate a total estimated time of arrival based on the one or more respective ETAs and the one or more respective probabilities. The apparatus is further caused to provide the total estimated time of arrival as an output to a location-based service.

According to another embodiment, an apparatus comprises means for determining, by a processor, an uncertainty time window that spans from a timestamp of a location point of a sparse location data feed to a time of interest. The sparse location data feed is determined from at least one location sensor of a device. The apparatus also comprises means for determining a speed of the device at the location point based on the sparse location data feed. The apparatus further comprises means for processing map data based on the speed to predict one or more possible locations to which the device may have traveled during the uncertainty time window and to determine one or more respective probabilities of the device has traveled to the one or more possible locations. The apparatus further comprises means for determining one or more respective estimated times of arrival (ETAs) at a destination from the one or more possible locations. The apparatus further comprises means for calculating a total estimated time of arrival based on the one or more respective ETAs and the one or more respective probabilities. The apparatus further comprises means for providing the total estimated time of arrival as an output to a location-based service.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing an estimated time of arrival (ETA) with a uncertain starting location, according to one embodiment;

FIG. 2 is a diagram of an example process for providing an estimated time of arrival with a uncertain starting location, according to one embodiment;

FIG. 3 is a diagram of components of an ETA platform capable of providing an estimated time of arrival with a uncertain starting location, according to one embodiment;

FIG. 4 is a flowchart of a process for providing an estimated time of arrival with a uncertain starting location, according to one embodiment;

FIG. 5 is a diagram of an example user interface depicting a total estimated time of arrival (UETA), according to one embodiment;

FIG. 6 is a diagram of a geographic database, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal (e.g., handset or vehicle or part thereof) that can be used to implement an embodiment.

### DESCRIPTION OF SOME EMBODIMENTS

Examples of a method, apparatus, and computer program for providing an estimated time of arrival with a uncertain starting location are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

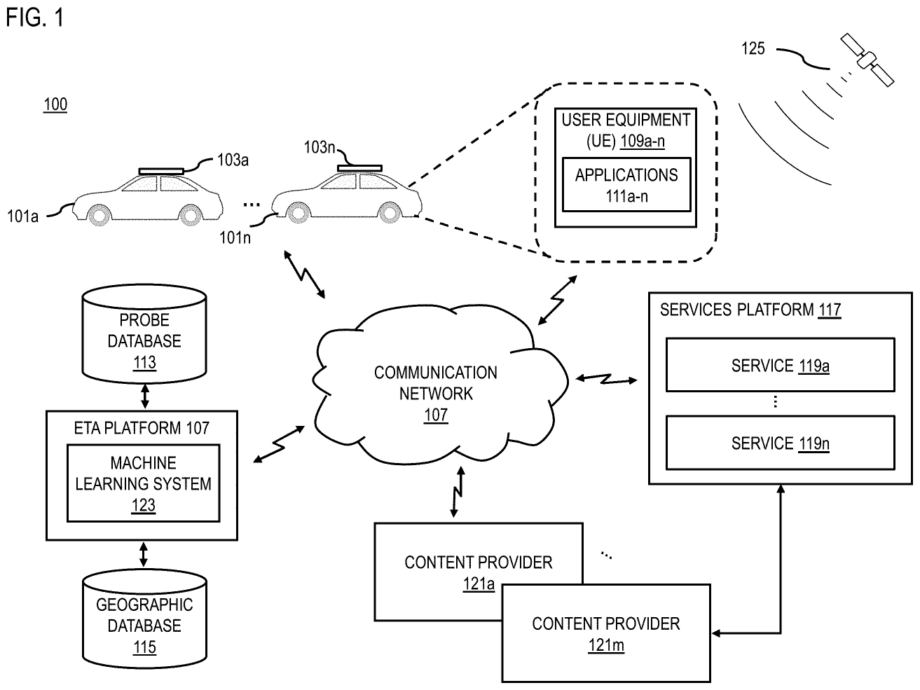

FIG. 1 is a diagram of a system capable of providing an estimated time of arrival (ETA) with a uncertain starting location (i.e., of a vehicle), according to one embodiment. Travel time is a basic attribute considered by various mobility services, such as personal navigation, travel planning, ride-hailing, ridesharing, fleet management, etc. The users of the mobility services make decisions based on an average travel time or ETA.

Navigation and mapping service providers are continually challenged to optimize urban mobility. One area of interest has been improving user experience of location-based services, such as ride-hailing, ridesharing, etc. In many real world mobility services, when a backend system running an optimizing algorithm (such as choosing the best taxi, or simply estimating its ETA) only has access to GPS coordinates taken in a sparse way, the backend system is uncertain regarding a starting location of a target vehicle (e.g., the taxi). As mentioned, most GPS sensors in user devices emit GPS data feeds (location points) at designated sampling frequencies (e.g., every 5 seconds, 10 seconds, 30 seconds, etc.) (i.e., in a sparse manner) to conserve resources consumption, such as battery power, bandwidth, storage, calculation time, etc.

In many mobility related algorithms, ETA is generated as a sole output or used as an input in a bigger optimizing algorithm for urban navigation. In urban scenarios, many of the routes for which to calculate ETAs are relatively short. As such, the sparsity of the location sensor data feed (e.g., GPS data) leads to uncertainty of a starting location of a vehicle (e.g., a taxi), and its estimated time of arrival (ETA). Therefore, the existing ETA solutions simply assume the last known location of the vehicle or the last known map-matched location of the vehicle (thus correcting GPS errors) as the starting location of the vehicle. The existing ETA solutions then use the starting location and the heading of the vehicle at a starting time to estimate an ETA, in conjunction with either only historical ETA data or the historical ETA data plus routing map data. These solutions The is no solution dealing specifically with short term ETA predictions that addresses both GPS errors and timedelta errors due to GPS sparsity. A timedelta errors occur during a time window/duration absent of GPS data which is a result of GPS sparsity. Such timedelta/window/duration can be between a time of interest (e.g., a current time) and a past time point when the vehicle was at a location point of a sparse location data feed (e.g., a last known location). Such short term ETA predictions and timedelta errors due to GPS sparsity can be magnified in urban short term settings.

Referring back to the taxi example, a taxi is usually close by a pickup location and can arrive in less than 10 minutes. For such a short distance, a small difference of the starting location and/or a driving direction can significantly change their respective ETAs. For example, during a 30-second time window (“timedelta”), the taxi may or may not turn into a long one-way street leading towards the opposite direction of the pickup destination. Such a turn may double ETA. The existing ETA solutions do not address to such timedelta errors due to GPS sparsity.

To address these problems, the system 100 of FIG. 1 introduces a capability to provide an ETA with a uncertain starting location (i.e., of a vehicle), by translates the starting location uncertainty in a sparse GPS data feed into a weighted average of multiple sources using sensor data and map data to estimate velocity, possible locations, and a total estimated time of arrival (UETA). It is noted that the term “starting location” refers to an estimated location of a probe (e.g., a vehicle or a user device travelling with the vehicle) at a time of interest (any time, e.g., a current time) after a uncertainty time window passed since the vehicle was at a location point of a sparse location data feed (e.g., a last known location). The term “sparse location data feed” is a location data feed including location data points captured by a location sensor at designated sampling frequencies (e.g., every 5 seconds, 10 seconds, 30 seconds, etc.). As mentioned, this sparse data creates the uncertainty time window or time delta error between any two location data points during which the vehicle/user's location and/or route taken is uncertain or not known.

The system 100 can improve the ETA prediction for short rides in various cases where many turns and locations are possible. As such, the system 100 can calculate a change in ETA due to GPS sparsity, which can be a difference between the UETA and an original ETA determined based on the existing methods), thereby correcting the ETA difference/error accordingly. The system 100 cab be used in handling many mobility optimization applications, such as ride-hailing, ridesharing, etc., for example, to provide the UETA to the riders and drivers, so the users will have better expectation based on UETA (i.e., more likely ETA).

In one embodiment, the system 100 collects a plurality of instances of probe data and/or vehicle sensor data from one or more vehicles 101a-101n (also collectively referred to as vehicles 101) (e.g., autonomous vehicles, HAD vehicles, semi-autonomous vehicles, etc.) having one or more vehicle sensors 103a-103n (also collectively referred to as vehicle sensors 103) (e.g., global positioning system (GPS), LiDAR, camera sensor, etc.) and having connectivity to an ETA platform 105 via a communication network 107. In one instance, the real-time probe data may be reported as probe points, which are individual data records collected at a point in time that records telemetry data for that point in time. A probe point can include attributes such as: (1) probe ID, (2) longitude, (3) latitude, (4) heading, (5) speed, and (6) time.

In one instance, the system 100 can also collect the real-time probe data and/or sensor data from one or more user equipment (UE) 109a-109n (also collectively referenced to herein as UEs 109) associated with the a vehicle 101 (e.g., an embedded navigation system), a user or a passenger of a vehicle 101 (e.g., a mobile device, a smartphone, etc.), or a combination thereof. In one instance, the UEs 109 may include one or more applications 111a-111n (also collectively referred to herein as applications 111) (e.g., a navigation or mapping application). In one embodiment, the probe data and/or sensor data collected may be stored in the probe database 113, the geographic database 115, or a combination thereof.

In one instance, the system 100 may also collect real-time probe data and/or sensor data from one or more other sources such as government/municipality agencies, local or community agencies (e.g., a police department), and/or third-party official/semi-official sources (e.g., a services platform 117, one or more services 119a-119n, one or more content providers 121a-121m, etc.).

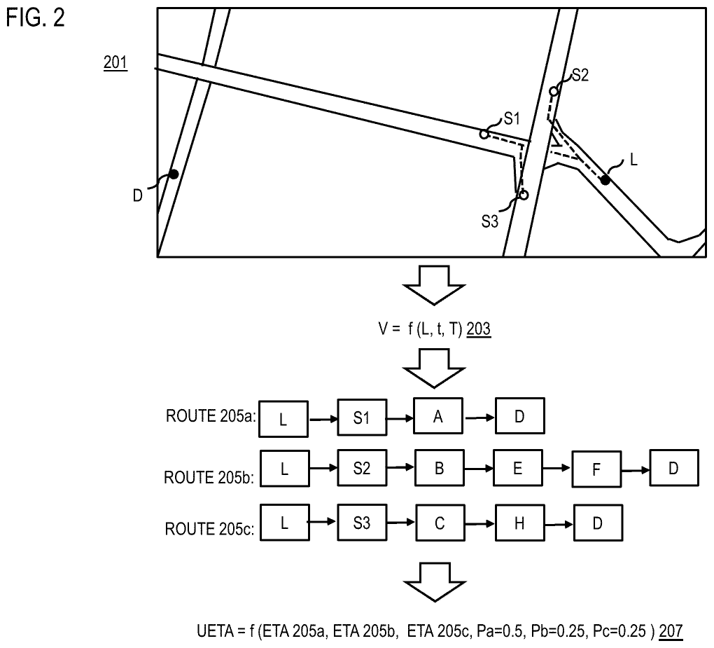

FIG. 2 is a diagram of an example use case for providing an estimated time of arrival with a uncertain starting location, according to one embodiment. By way of example, a vehicle 101 was last reported at a time “t” at a location point “L” (i.e., a last known location) based on a real-time sparse location data feed reported by the vehicle 101 as shown in a map 201. The system 100 can calculate an ETA from location L to a destination “D” as 3.5 minutes. Although the system 100 does not have a current location of the vehicle 101 during a location data reporting time window/interval (“T”), the system 100 can calculate a speed (“v”) of the vehicle 101 based on the real-time sparse location data feed, using a formula 203: v=f (L, t, T). By way of example, the speed v of the vehicle 101 is calculated from two reported location points of the sparse location data feed.

In addition, the system 100 can determine possible locations S1-S3 on different streets around location L that the vehicle 101 travelled to via routes 205a-205c at speed v during the reporting time window/interval T, based on map data stored locally or retrieved from the geographical database 115. The system 100 can determine the respective probabilities Pa-Pc of traveling to S1-S3 as, for example, Pa=0.5, Pb=0.25, Pc=0.25, based on historical traffic data, a machine learning model, etc. In other words, there is 50% likelihood that the vehicle 101 will go straight to reach location S1, 25% likelihood that the vehicle 101 will turn right to reach location S2, and 25% likelihood that the vehicle 101 will turn left to reach location S3.

The system 100 then can calculate a total estimated time of arrival (“UETA”) based on individual ETAs from the possible locations S1-S3 and their respective probabilities, using a formula 207: UETA=f (ETA 205a, ETA 205b, ETA 205c, Pa=0.5, Pb=0.25, Pc=0.25). For example, from location S1, the vehicle 101 can continue route 205a by making a left turn at location A to reach destination D, and the ETA is 3 minutes. From location S2, the vehicle 101 can continue route 205b via take an exit off the highway at location B, make a left turn at location E, and make a right turn at location F to reach destination D, and the ETA is 10 minutes. From location S3, the vehicle 101 can continue route 205c via taking an exit of the highway at a location C on the highway, take a right turn at location H to reach destination D, and the ETA is 20 minutes. In this example, UETA=0.5*3+0.25*10+0.25*20=9 (min).

In one embodiment, the real-time sparse location data feed is received directly from the vehicle 101. In this embodiment, vehicle 101 can be configured to report probe data and/or sensor data (e.g., via a vehicle sensor 103, a UE 109, or a combination thereof) as probe points, which are individual data records collected at a point in time that records telemetry data for the vehicle 101 for that point in time. In another embodiment, the real-time sparse location data feed is received from one or more third party probe data aggregators, the probe database 113, or a combination thereof. In one embodiment, a probe point may include the following five attributes (by way of illustration and not limitation): (1) probe ID; (2) longitude; (3) latitude; (4) speed; and (5) time.

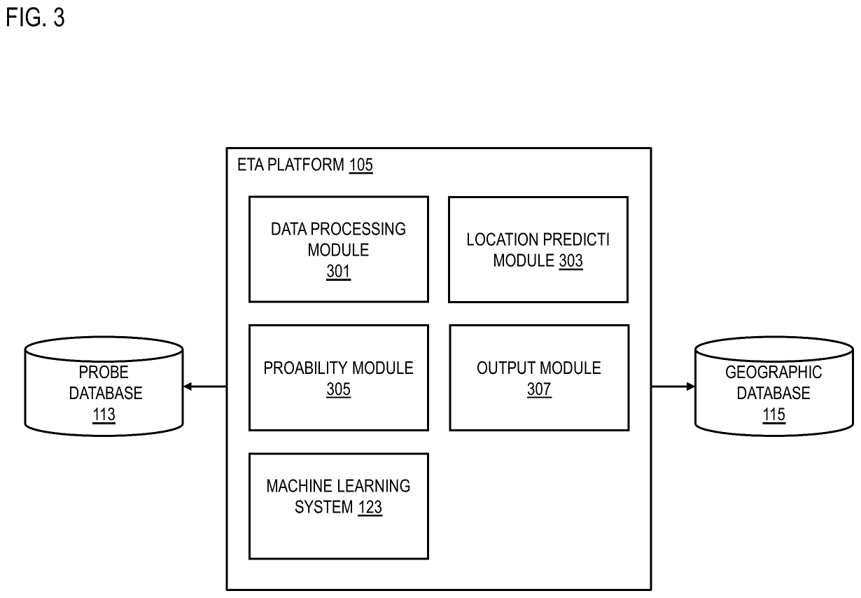

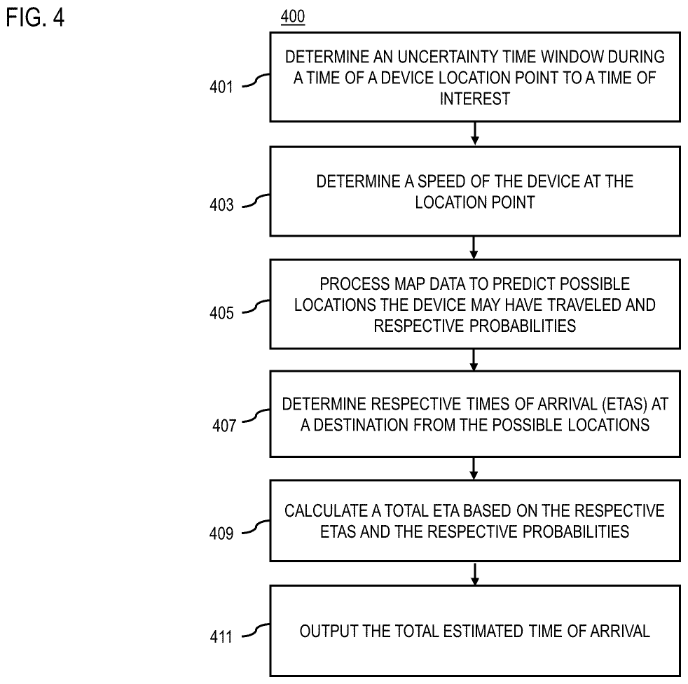

FIG. 3 is a diagram of the components of the ETA platform 105, according to one embodiment. By way of example, the ETA platform 105 includes one or more components for providing an estimated time of arrival with a uncertain starting location, according to the various embodiments described herein. It is contemplated that the functions of these components may be combined or performed by other components of equivalent functionality. In one embodiment, the ETA platform 105 includes a data processing module 301, a location predication module 303, a probability module 305, a communication module 307, and a machine learning system 123 has connectivity to the probe database 113 and the geographic database 115. The above presented modules and components of the ETA platform 105 can be implemented in hardware, firmware, software, or a combination thereof. Though depicted as a separate entity in FIG. 1, it is contemplated that the ETA platform 105 may be implemented as a module of any other component of the system 100. In another embodiment, the ETA platform 105, the machine learning system 123, and/or the modules 301-307 may be implemented as a cloud-based service, local service, native application, or combination thereof. The functions of the ETA platform 105, the machine learning system 123, and/or the modules 301-307 are discussed with respect to FIG. 4.

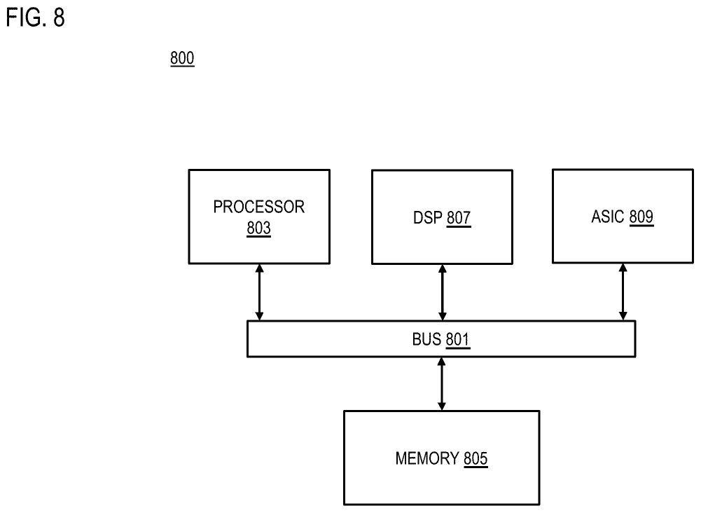

FIG. 4 is a flowchart of a process for providing an estimated time of arrival with a uncertain starting location, according to one embodiment. In various embodiments, the ETA platform 105, the machine learning system 123, and/or any of the modules 301-307 may perform one or more portions of the process 400 and may be implemented in, for instance, a chip set including a processor and a memory as shown in FIG. 8. As such, the ETA platform 105 and/or the modules 301-307 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, the data processing module 301 can map-match the probe data and/or sensor data by processing the real-time sparse location data feed (e.g., probe data comprising GPS trace points or other location data) to identify which road, path, link, etc. a probe device (e.g., a vehicle 101, a UE 109, etc.) is travelling. The map matching process, for example, enables the data processing module 301 to correlate each location data point of a vehicle 101 to a corresponding location on a segment of the road network.

In step 401, the data processing module 301 can determine an uncertainty time window “T” that spans from a timestamp of a location point (e.g., a GPS point) of a sparse location data feed to a time of interest (e.g., a time of possible location and probability assignment). The sparse location data feed is determined from at least one location sensor of a device (e.g., UE 109). By way of example, the location point “L” is a last reported location point of the sparse location data feed, and the time of interest is a current time “t”.

In step 403, the data processing module 301 can determine a speed of the device (e.g., UE 109) at the location point “L” based on the sparse location data feed. In one embodiment, the speed “v” is determined from at last two reported location points of the sparse location data feed. By way of example, the data processing module 301 can calculate an effective speed ‘v’ based on previous two GPS tracks.

In step 405, the location prediction module 303 can process map data based on the speed “v” to predict one or more possible locations “S” to which the device (e.g., UE 109) may have traveled during the uncertainty time window “T” and to determine one or more respective probabilities “P” of the device has traveled to the one or more possible locations “S”, by working in conjunction with the probability module 305.

By way of example, the location prediction module 303 can process map data retrieved from the geographic database 115 to determine that the vehicle 101 take different maneuver options, for example, different turn maneuvers including going straight (no turn), turning right, turning left at the location point “L”, that lead to different streets. The maneuver options for a real world decision point/location varies depending on the road layout, traffic, weather, etc. around the location. These three maneuver options are provided by way of simplified illustration and not as a limitation.

The location prediction module 303 can then determine the possible locations (e.g., S1-S3) reached at a time point “t+T” from the location “L” based on the speed “v”, the time window “T” (e.g., 30 seconds), and the maneuver options go straight, turn right, or turn left near the location point “L”. For examples, from the location point “L”, the vehicle 101 can reach the possible location S1 by going straight (i.e., no turning) at speed “v” during the window “T”, the vehicle 101 can reach the possible location S2 by turning right at speed “v” during the period “T”, and the vehicle 101 can reach the possible location S3 by turning left at speed “v” during the period “T.”

In one instance, the location prediction module 303 can assume the vehicle 101 travels the same distance (e.g., v*T) to S1-S3 at speed “v” during the period “T” via the different maneuver options. In another instance, the location prediction module 303 further considers traffic signs, real-time and/or historical traffic data, etc. associated with the maneuver options, to adjust the speed “vi” for each maneuver option and determine the respective distances (e.g., vi*T) to S1-S3.

In one embodiment, the probability module 305 can use one or more statistical or probability models to describe a probe maneuver activity distribution (e.g., probe count distribution of maneuver activities), depending on a maneuver activity type (e.g., turning, passing, merging onto a highway, braking, parking, etc.), the properties of the underlying road segment/network, etc. In other words, the probability module 305 can use any suitable statistic or discrete probability distribution to determine the odds or the likelihood of the possible probe maneuver activities (e.g., turning) such as but not limited to a uniform distribution, a Poisson distribution, a Gaussian approximation of the Poisson distribution, or the like. By way of example, the one or more respective turn probabilities are determined based on a uniform distribution. Referring back to the example depicted in FIG. 2, the probability module 305 can set a going straight (no turn) probability Pa=0.33, a turning right probability Pb=0.33, a turning right probability Pc=0.33 based on a uniform distribution.

In another embodiment, the one or more respective probabilities are determined based on historical traffic data. In this instance, the probability module 305 can retrieve historical traffic data associated with the location point “L” and the nearby road segment/network data from the geographic database 115. The historical traffic data may already include the probability data of Pa, Pb, Pc. Otherwise, the probability module 305 can calculate the probability data of Pa, Pb, Pc based on the actual counts of going straight instances, turning right instances, and turning right instances at a time of the day/week/month corresponding to the time “t”. As a result, the probability module 305 can set Pa=0.5, Pb=0.25, Pc=0.25 based on historical traffic data for the time “t”.

In yet another embodiment, the one or more respective probabilities are determined using machine learning. In one instance, the machine learning is based on one or more features. Referring back to the Examiner depicted in FIG. 2, the one or more features can include a historic average of turns per time, a time of day, current traffic, a user preference, or a combination thereof.

In one instance, the historic average of turns per time can be defined as historic average counts of turns with respect to a location as a function of time, and high counts can be converted into higher probabilities. By way of example, more counts of the right turn than a count of going straight during morning rush hours, while more counts of the left turn than a count of going straight during after rush hours. In another instance, the probability module 305 can factor a current traffic on the street where the right turn will lead to by lower the probability of turning right. In other instances, the user preference may be associated with one or more contextual attributes, such as a transport mode, a travel speed, calendar data, etc. to tailor the probabilities to the user.

In one embodiment, the probability module 305 in connection with the machine learning system 123 can select respective weights of the one or more features. In one embodiment, the probability module 305 can train the machine learning system 123 to select or assign respective weights, correlations, relationships, etc. among the ranking criteria, the information types, the contextual attributes, the one or more features, or a combination thereof, for determining the possible locations and respective probabilities. In one instance, the probability module 305 can continuously provide and/or update a machine learning model (e.g., a support vector machine (SVM), neural network, decision tree, etc.) of the machine learning system 123 during training using, for instance, supervised deep convolution networks or equivalents. In other words, the probability module 305 trains the machine learning model using the respective weights of the one or more features to most efficiently select the possible locations and the respective probabilities, in order to render a total estimated time of arrival (UETA) as follows.

In step 407, the data processing module 301 can determine one or more respective estimated times of arrival (ETAs) at a destination from the one or more possible locations “S”. Referring back to the example depicted in FIG. 2, the data processing module 301 can calculate a set ‘E’ of ETAs from each point (e.g., S1-S3) in ‘S’ to the destination D using statistical methods with an estimated variance set ‘V’. In probability statistics, variance is a standard statistical variance, i.e., the expectation of the squared deviation (SD) of a random variable from its mean. In one embodiment, the data processing module 301 can determine av estimated variance set ‘V’ by measuring how far the set ‘E’ of ETAs are spread out from their average value.

In step 409, the data processing module 301 can calculate the UETA based on the one or more respective estimated times of arrival and the one or more respective probabilities. In one embodiment, the UETA is based on a weighted average of the one or more respective times of arrival with the one or more respective probabilities used for weighting. For example, the UETA can be a weighted average of ‘E’ with weights ‘P’, and expressed as a formula: UETA=sum_i {ETA|si}

In one embodiment, the data processing module 301 can determine a variance estimation of the UETA (“Var(UETA)”) based on a variance decomposition rule. For example, the Var(UETA) can be defined via variables Vi, Pi, and Ei associated with respective possible location Si are random on the same probability space, and the variance of UETA is finite, and expressed as a variance decomposition formula: Var(UETA)=sum_over_i {Vi*Pi}+(sum_over_i {Pi*Ei\hat{ }2}−[sum_over_i {Pi*Ei}]\hat{ }2)

In one embodiment, the UETA is calculated for a trip to the destination that is less than a threshold trip length. By way of example, such short trip can last 5 minutes, yet the data processing module 301 can calculate the UETA considering the possible distances travelling during the time window “T” (when the location data is absent due to GPS sparsity), and the subsequent distances travelled form the possible locations to the destination D.

In step 411, the output module 307 can provide the UETA as an output to a location-based service. By way of example, the location-based service is a ride-hailing service or a ridesharing service.

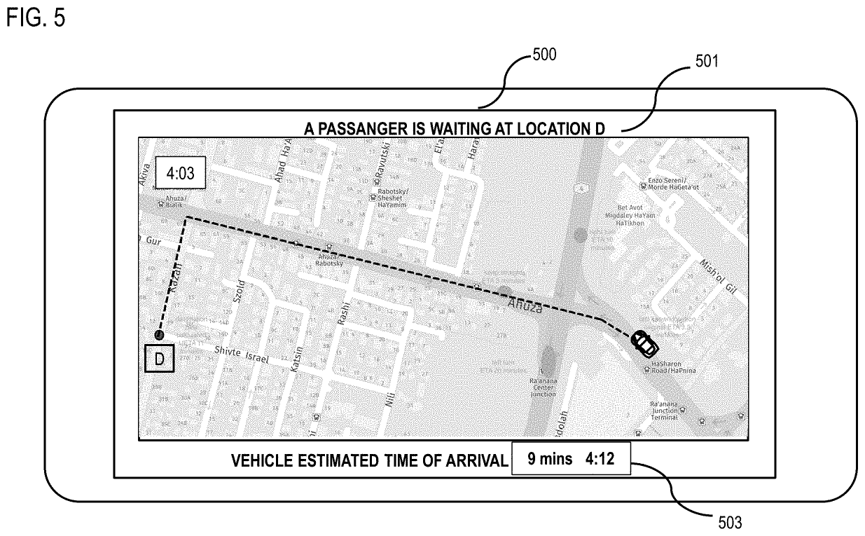

In one embodiment, the output module 307 may provide the output to a vehicle 101, a user of the vehicle 101 (e.g., a driver or a passenger), or a combination thereof via a UE 109 (e.g., an embedded navigation system, a mobile device, etc.) and/or an application 111 running on the UE 109 (e.g., a navigation application). FIG. 5 is a diagram of an example user interface 500 depicting a total estimated time of arrival, according to one embodiment. The user interface 500 shows a current time 4:03 and a notification 501 of “a passenger waiting at location D”. The user interface 500 also shows a notification 503 of the UETA (e.g., 9 minutes 4:12) via a navigation or mapping application 111 of a UE 109 when waiting for a vehicle 101 (e.g., a taxi, a shared vehicle, etc.).

In one embodiment, the output module 307 can provide the Var(UETA) as part of the output to the data processing module 301 for training the machine learning model. In another embodiment, the output module 307 can output to the geographic database 115 the probability data, UETA data, respective variance data, Var(UETA) data, etc. corresponding to a vehicle 101 for future use and/or training of the machine learning system 123, to improve the speed and accuracy of the UETA processes of the ETA platform 105.

Based actual GPS data of a sample city, the system 100 calculates UETA for short rides (e.g., 5 minutes) with heading information yields significant improvement over UETA calculated without heading information. In one instance, UETA results are similar on 80% of the GPS tracks, but are much better in the remaining 20% of the GPS tracks. For example, the 20% of the GPS tracks can occur in a short time window a moving vehicle can change its location by taking certain turns in a way that is similar to reverting its heading. Therefore, the system 100 can significantly improve ETA calculation for at least 20% of the short rides.

The above-discussed embodiments improve ETA using map data to predict ETA for short rides with a location uncertainty within a timeframe ‘T’. The improvement is high for some low coverage and/or high impact cases in urban settings, such as ride-hailing and carsharing.

Returning to FIG. 1, in one embodiment, the ETA platform 105 has connectivity over the communication network 107 to the services platform 117 (e.g., an OEM platform) that provides one or more services 119a-119n (also collectively referred to herein as services 119) (e.g., probe and/or sensor data collection services). By way of example, the services 119 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 117 uses the output (e.g. lane-level dangerous slowdown event detection and messages) of the ETA platform 105 to provide services such as navigation, mapping, other location-based services, etc.

In one embodiment, the ETA platform 105 may be a platform with multiple interconnected components. The ETA platform 105 may include multiple servers, intelligent networking devices, computing devices, components and corresponding software for providing parametric representations of lane lines. In addition, it is noted that the ETA platform 105 may be a separate entity of the system 100, a part of the services platform 117, a part of the one or more services 119, or included within the vehicles 101 (e.g., an embedded navigation system).

In one embodiment, content providers 121a-121m (also collectively referred to herein as content providers 121) may provide content or data (e.g., including probe data, sensor data, etc.) to the ETA platform 105, the UEs 109, the applications 111, the probe database 113, the geographic database 115, the services platform 117, the services 119, and the vehicles 101. The content provided may be any type of content, such as map content, textual content, audio content, video content, image content, etc. In one embodiment, the content providers 121 may provide content that may aid in localizing a vehicle path or trajectory on a lane of a digital map or link. In one embodiment, the content providers 121 may also store content associated with the ETA platform 105, the probe database 113, the geographic database 115, the services platform 117, the services 119, and/or the vehicles 101. In another embodiment, the content providers 121 may manage access to a central repository of data, and offer a consistent, standard interface to data, such as a repository of the geographic database 115.

By way of example, the UEs 109 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 109 can support any type of interface to the user (such as “wearable” circuitry, etc.). In one embodiment, a UE 109 may be associated with a vehicle 101 (e.g., a mobile device) or be a component part of the vehicle 101 (e.g., an embedded navigation system). In one embodiment, the UEs 109 may include the ETA platform 105 to provide an estimated time of arrival with a uncertain starting location.

In one embodiment, as mentioned above, the vehicles 101, for instance, are part of a probe-based system for collecting probe data and/or sensor data for detecting traffic incidents (e.g., dangerous slowdown events) and/or measuring traffic conditions in a road network. In one embodiment, each vehicle 101 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 101 may include sensors 103 for reporting measuring and/or reporting attributes. The attributes can also be any attribute normally collected by an on-board diagnostic (OBD) system of the vehicle 101, and available through an interface to the OBD system (e.g., OBD II interface or other similar interface).

The probe points can be reported from the vehicles 101 in real-time, in batches, continuously, or at any other frequency requested by the system 100 over, for instance, the communication network 107 for processing by the ETA platform 105. The probe points also can be map matched to specific road links stored in the geographic database 115. In one embodiment, the system 100 (e.g., via the ETA platform 105) can generate probe traces (e.g., vehicle paths or trajectories) from the probe points for an individual probe so that the probe traces represent a travel trajectory or vehicle path of the probe through the road network.

In one embodiment, as previously stated, the vehicles 101 are configured with various sensors (e.g., vehicle sensors 103) for generating or collecting probe data, sensor data, related geographic/map data, etc. In one embodiment, the sensed data represents sensor data associated with a geographic location or coordinates at which the sensor data was collected. In one embodiment, the probe data (e.g., stored in the probe database 113) includes location probes collected by one or more vehicle sensors 103. By way of example, the vehicle sensors 103 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 101, switch sensors for determining whether one or more vehicle switches are engaged, and the like. Though depicted as automobiles, it is contemplated the vehicles 101 can be any type of vehicle manned or unmanned (e.g., cars, trucks, buses, vans, motorcycles, scooters, drones, etc.) that travel through road segments of a road network.

Other examples of sensors 103 of the vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle 101 along a path of travel (e.g., while on a hill or a cliff), moisture sensors, pressure sensors, etc. In a further example embodiment, sensors 103 about the perimeter of the vehicle 101 may detect the relative distance of the vehicle 101 from a physical divider, a lane line of a link or roadway, the presence of other vehicles, pedestrians, traffic lights, potholes and any other objects, or a combination thereof. In one scenario, the vehicle sensors 103 may detect weather data, traffic information, or a combination thereof. In one embodiment, the vehicles 101 may include GPS or other satellite-based receivers 103 to obtain geographic coordinates from satellites 125 for determining current location and time. Further, the location can be determined by visual odometry, triangulation systems such as A-GPS, Cell of Origin, or other location extrapolation technologies.

In one embodiment, the UEs 109 may also be configured with various sensors (not shown for illustrative convenience) for acquiring and/or generating probe data and/or sensor data associated with a vehicle 101, a driver, other vehicles, conditions regarding the driving environment or roadway, etc. For example, such sensors may be used as GPS receivers for interacting with the one or more satellites 125 to determine and track the current speed, position and location of a vehicle 101 travelling along a link or roadway. In addition, the sensors may gather tilt data (e.g., a degree of incline or decline of the vehicle during travel), motion data, light data, sound data, image data, weather data, temporal data and other data associated with the vehicles 101 and/or UEs 109. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via communication network 107 as probe data (e.g., GPS probe data) according to any known wireless communication protocols. For example, each UE 109, application 111, user, and/or vehicle 101 may be assigned a unique probe identifier (probe ID) for use in reporting or transmitting said probe data collected by the vehicles 101 and/or UEs 109. In one embodiment, each vehicle 101 and/or UE 109 is configured to report probe data as probe points, which are individual data records collected at a point in time that records telemetry data.

In one embodiment, the ETA platform 105 retrieves aggregated probe points gathered and/or generated by the vehicle sensors 103 and/or the UE 109 resulting from the travel of the UEs 109 and/or vehicles 101 on a road segment of a road network. In one instance, the probe database 113 stores a plurality of probe points and/or trajectories generated by different vehicle sensors 103, UEs 109, applications 111, vehicles 101, etc. over a period while traveling in a monitored area. A time sequence of probe points specifies a trajectory—i.e., a path traversed by a UE 109, application 111, vehicle 101, etc. over the period.

In one embodiment, the communication network 107 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 101, vehicle sensors 103, ETA platform 105, UEs 109, applications 111, services platform 117, services 119, content providers 121, and/or satellites 125 communicate with each other and other components of the system 100 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

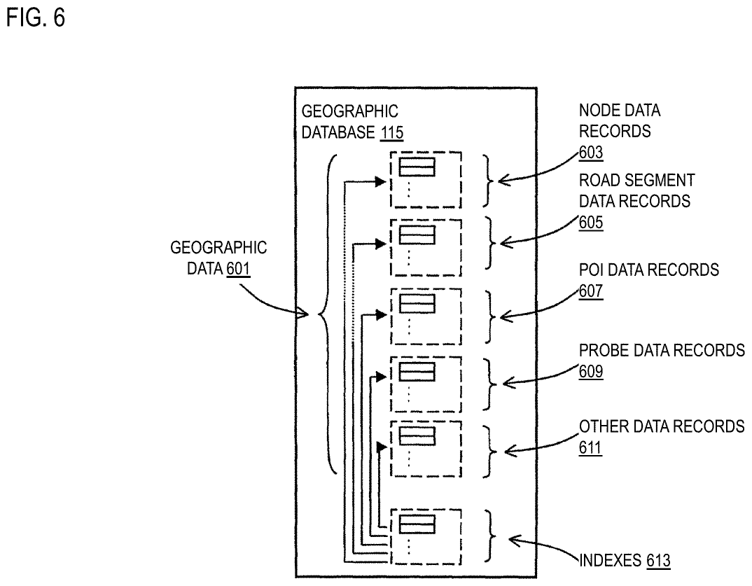

FIG. 6 is a diagram of a geographic database, according to one embodiment. In exemplary embodiments, probe data can be stored, associated with, and/or linked to the geographic database 115 or data thereof. In one embodiment, the geographic database 115 includes geographic data 601 used for (or configured to be compiled to be used for) mapping and/or navigation-related services, such as for personalized route determination, according to one embodiment. For example, the geographic database 115 includes node data records 603, road segment or link data records 605, POI data records 607, probe data records 609, other data records 611, and indexes 613. More, fewer or different data records can be provided. In one embodiment, the other data records 611 include cartographic (“carto”) data records, routing data, and maneuver data. In one embodiment, the probe data (e.g., collected from vehicles 101) can be map-matched to respective map or geographic records via position or GPS data associations (such as using known or future map matching or geo-coding techniques), for example. In one embodiment, the indexes 613 may improve the speed of data retrieval operations in the geographic database 115. The indexes 613 may be used to quickly locate data without having to search every row in the geographic database 115 every time it is accessed.

In various embodiments, the road segment data records 605 are links or segments representing roads, streets, paths, or lanes within multi-lane roads/streets/paths as can be used in the calculated route or recorded route information for determination of one or more personalized routes, according to exemplary embodiments. The node data records 603 are end points corresponding to the respective links or segments of the road segment data records 605. The road segment data records 605 and the node data records 603 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, lane number, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 607. The geographic database 115 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position within a city).

In one embodiment, the geographic database 115 can include probe data collected from vehicles 101 (e.g., probe vehicles). As previously discussed, the probe data include probe points collected from the vehicles 101 and include telemetry data from the vehicles 101 can be used to indicate the traffic conditions at the location in a roadway from which the probe data was collected. In one embodiment, the probe data can be map-matched to the road network or roadways stored in the probe database 113, the geographic database 115, or a combination thereof. In one embodiment, the probe data can be further map-matched to individual lanes (e.g., any of the travel lanes, shoulder lanes, restricted lanes, service lanes, etc.) of the roadways for subsequent processing according to the various embodiments described herein. By way of example, the map-matching can be performed by matching the geographic coordinates (e.g., longitude and latitude) recorded for a probe-point against a roadway or lane within a multi-lane roadway corresponding to the coordinates.

The geographic database 115 can be maintained by a content provider 121 in association with the services platform 117 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used. In one embodiment, the data can include incident reports which can then be designated as ground truths for training a machine learning classifier to classify a traffic from probe data. Different sources of the incident report can be treated differently. For example, incident reports from municipal sources and field personnel can be treated as ground truths, while crowd-sourced reports originating from the general public may be excluded as ground truths.

The geographic database 115 can be a master geographic database stored in a format that facilitates updating, maintenance, and development. For example, the master geographic database 115 or data in the master geographic database 115 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 109, for example. The navigation-related functions can correspond to vehicle navigation, pedestrian navigation, or other types of navigation. The compilation of the mapping and/or probe data to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 115 can be a master geographic database, but in alternate embodiments, the geographic database 115 can represent a compiled navigation database that can be used in or with end user devices (e.g., UEs 109) to provide navigation-related functions. For example, the geographic database 115 can be used with the end user device UE 109 to provide an end user with navigation features. In such a case, the geographic database 115 can be downloaded or stored on the end user device UE 109, such as in applications 111, or the end user device UE 109 can access the geographic database 115 through a wireless or wired connection (such as via a server and/or the communication network 107), for example.

The processes described herein for providing an estimated time of arrival with a uncertain starting location may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

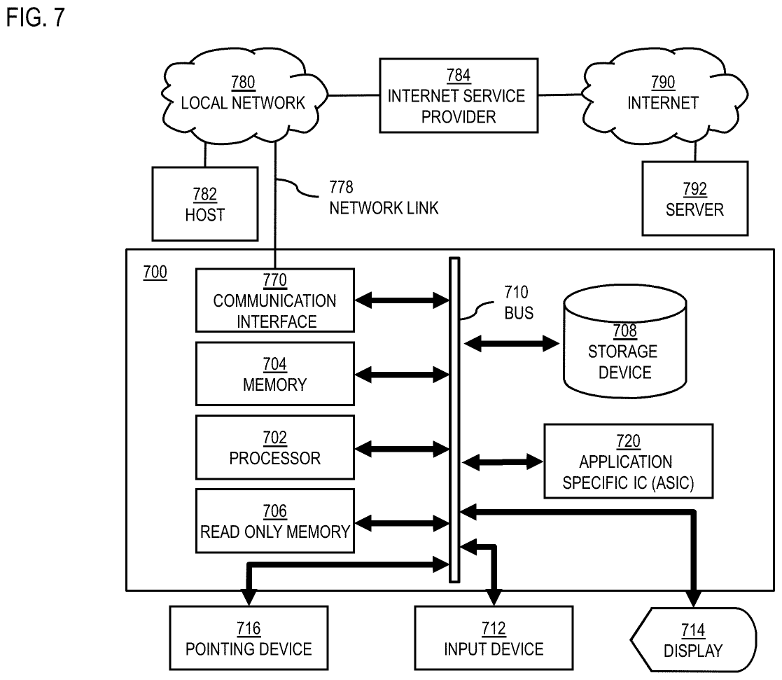

FIG. 7 illustrates a computer system 700 upon which an embodiment of the invention may be implemented. Computer system 700 is programmed (e.g., via computer program code or instructions) to provide an estimated time of arrival with a uncertain starting location as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to providing an estimated time of arrival with a uncertain starting location. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions providing an estimated time of arrival with a uncertain starting location. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions providing an estimated time of arrival with a uncertain starting location, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 providing an estimated time of arrival with a uncertain starting location to the UE 109.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to provide an estimated time of arrival with a uncertain starting location as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real-time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide an estimated time of arrival with a uncertain starting location. The memory 805 also stores the data associated with or generated by the execution of the inventive steps.

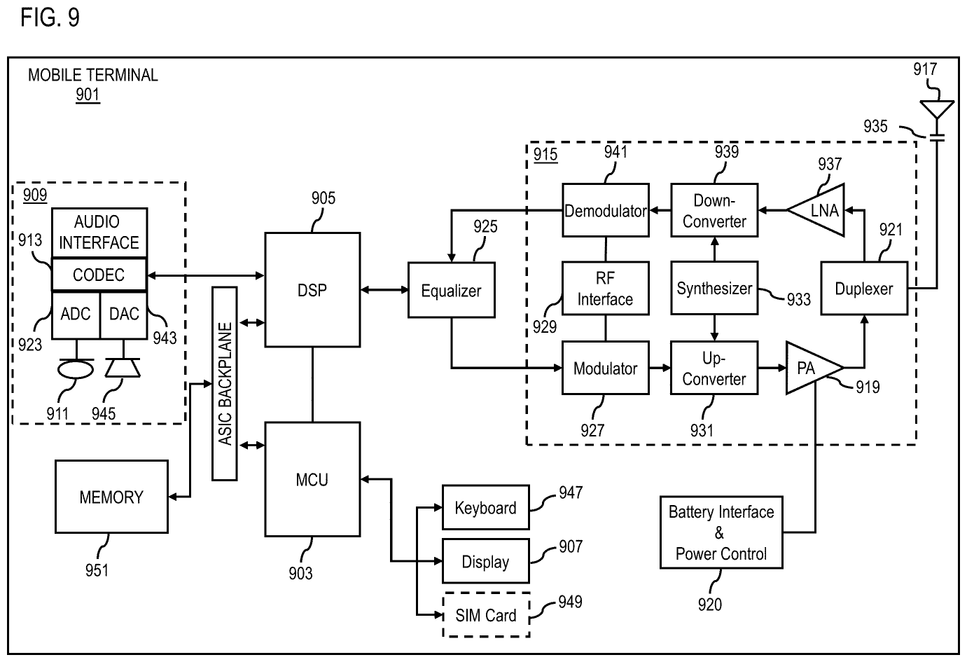

FIG. 9 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to provide an estimated time of arrival with a uncertain starting location. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining, by a processor, an uncertainty time window that spans from a timestamp of a location point of a sparse location data feed to a time of interest, wherein the sparse location data feed is determined from at least one location sensor of a device;
determining a speed of the device at the location point based on the sparse location data feed;
processing map data based on the speed to predict one or more possible locations to which the device may have traveled during the uncertainty time window and to determine one or more respective probabilities of the device has traveled to the one or more possible locations;
determining one or more respective estimated times of arrival at a destination from the one or more possible locations;
calculating a total estimated time of arrival based on the one or more respective estimated times of arrival and the one or more respective probabilities; and
providing the total estimated time of arrival as an output to a location-based service.

2. The method of claim 1, wherein the total estimated time of arrival is based on a weighted average of the one or more respective times of arrival with the one or more respective probabilities used for weighting.

3. The method of claim 1, further comprising:
determining a variance estimation of the total estimated time of arrival based on a variance decomposition rule; and
providing the variance estimation as part of the output.

4. The method of claim 1, wherein the total estimated time of arrival is calculated for a trip to the destination that is less than a threshold trip length.

5. The method of claim 1, wherein the location point is a last reported location point of the sparse location data feed, and wherein the time of interest is a current time.

6. The method of claim 1, wherein the speed is determined from at last two reported location points of the sparse location data feed.

7. The method of claim 1, wherein the one or more respective probabilities are determined based on a uniform distribution.

8. The method of claim 1, wherein the one or more respective probabilities are determined based on historical traffic data.

9. The method of claim 1, wherein the one or more respective probabilities are determined using machine learning.

10. The method of claim 1, wherein the machine learning is based on one or more features, and wherein the one or more features include a historic average of turns per time, a time of day, current traffic, a user preference, or a combination thereof.

11. The method of claim 1, wherein the location-based service is a ride-hailing service or a ridesharing service.

12. An apparatus comprising:
at least one processor; and
at least one memory including computer program code for one or more programs, the at least one memory and the computer program code configured to, with the at least one processor, cause the apparatus to perform at least the following,
determine an uncertainty time window that spans from a timestamp of a location point of a sparse location data feed to a time of interest, wherein the sparse location data feed is determined from at least one location sensor of a device;
determine a speed of the device at the location point based on the sparse location data feed;
process map data based on the speed to predict one or more possible locations to which the device may have traveled during the uncertainty time window and to determine one or more respective probabilities of the device has traveled to the one or more possible locations;
determine one or more respective estimated times of arrival at a destination from the one or more possible locations;
calculate a total estimated time of arrival based on the one or more respective estimated times of arrival and the one or more respective probabilities; and
provide the total estimated time of arrival as an output to a location-based service.

13. The apparatus of claim 12, wherein the total estimated time of arrival is based on a weighted average of the one or more respective times of arrival with the one or more respective probabilities used for weighting.

14. The apparatus of claim 12, wherein the apparatus is further caused to:
determine a variance estimation of the total estimated time of arrival based on a variance decomposition rule; and
provide the variance estimation as part of the output.

15. The apparatus of claim 12, wherein the total estimated time of arrival is calculated for a trip to the destination that is less than a threshold trip length.

16. The apparatus of claim 12, wherein the location point is a last reported location point of the sparse location data feed, and wherein the time of interest is a current time.

17. The apparatus of claim 12, wherein the speed is determined from at last two reported location points of the sparse location data feed.

18. A non-transitory computer-readable storage medium, carrying one or more sequences of one or more instructions which, when executed by one or more processors, cause an apparatus to at least perform the following steps:
determining an uncertainty time window that spans from a timestamp of a location point of a sparse location data feed to a time of interest, wherein the sparse location data feed is determined from at least one location sensor of a device;
determining a speed of the device at the location point based on the sparse location data feed;
processing map data based on the speed to predict one or more possible locations to which the device may have traveled during the uncertainty time window and to determine one or more respective probabilities of the device has traveled to the one or more possible locations;
determining one or more respective estimated times of arrival at a destination from the one or more possible locations;
calculating a total estimated time of arrival based on the one or more respective estimated times of arrival and the one or more respective probabilities; and
providing the total estimated time of arrival as an output to a location-based service.

19. The non-transitory computer-readable storage medium of claim 18, wherein the total estimated time of arrival is based on a weighted average of the one or more respective times of arrival with the one or more respective probabilities used for weighting.

20. The non-transitory computer-readable storage medium of claim 18, wherein the apparatus is further caused to perform:
determining a variance estimation of the total estimated time of arrival based on a variance decomposition rule; and
providing the variance estimation as part of the output.
